(19) United States
(12) Patent Application Publication
(10) Pub. No.: US 2014/0366356 A1
(43) Pub. Date: Dec. 18, 2014

(54) METHOD FOR CHANGING TOOLS

(71) Applicant: MAGNA STEYR Fuel Systems GmbH, Sinabelkirchen (AT)

(72) Inventor: Bernhard SPARY, Nestelbach bei Graz (AT)

(21) Appl. No.: 14/302,490

(22) Filed: Jun. 12, 2014

(30) Foreign Application Priority Data
Jun. 12, 2013 (EP) 13171737.3

(51) Int. Cl. B29C 33/30; B29C 51/22; B29C 51/18

(52) U.S. Cl. CPC B29C 33/305; B29C 33/303; B29C 51/18; B29C 51/22
USPC 29/428

(57) ABSTRACT

A method for introducing tool sets into a thermoforming machine, in which the thermoforming machine has at least one work station for a tool set. The tool set, composed of an upper tool and a lower tool, is interconnected outside of the work station.

### CROSS-REFERENCE TO RELATED APPLICATIONS

The present application claims priority 35 U.S.C. §119 to European Patent Publication No. EP 13171737.3 (filed on Jun. 12, 2013) which is hereby incorporated by reference in its entirety.

### TECHNICAL FIELD

Embodiments relate to a method for introducing tool sets into a thermoforming machine, in which the thermoforming machine has at least one work station for a tool set and the tool set, composed of an upper tool and a lower tool, is interconnected outside of the work station.

### BACKGROUND

Thermoforming machines are widely used in the automotive industry. They are used, in particular, in the packaging industry for the production of structured film, etc. Plastic components are also widely used in the automotive industry. Here, thermoforming of films and sheets is distinguished by favourable tool costs and is particularly economical in the case of small and medium production runs. Examples of thermoformed parts include trim of all types. Furthermore, mudguards, fittings, plastic tanks and many more items are produced. It is, in particular, the combination of shaping, colouration and functionality which increasingly has manufacturers resorting to this process.

In principle, all thermoplastics can be processed in this process. If sheets are being processed, the cycle times for manufacturing a product become an important criterion, and for this reason, thermoforming machines having carousel tables or having pivot tables are employed.

The time required for changing a tool is significant as another important variable when it comes to employing machinery. The tools employed have to be positioned with high accuracy in order to avoid rejects or even damage to the tool and/or to the press. The time for a tool change is unproductive down time; it is, therefore, of great economic significance that this operation can be performed as fast as possible yet precisely.

### SUMMARY

Embodiments relate to a method which, in a simple manner and with high precision, enables a tool change in a thermoforming machine.

In accordance with embodiments, a method for introducing tool sets into a thermoforming machine, in which the thermoforming machine has at least one work station for a tool set composed of an upper tool and a lower tool, is interconnected outside of the work station, and includes at least one of the following: placing the tool set onto the work station; locking a movable plate of the machine in the operating position; displacing the lower tool, together with the upper tool, against the locked plate; centering and bracing the upper tool on the locked plate of the machine; and subsequently securing the lower tool in the position that is predetermined by the upper tool.

The tool is advantageously inserted into the machine in a rapid and precise manner by way of the method in accordance with the invention. Here, the upper tool forms the reference point to which the lower tool is aligned. On account thereof, an offset between the tools and any incidence of stress between the two tool parts is avoided. Advantageously, the two tool parts are preheated to the operating temperature outside of the machine. In this manner, a more rapid tool change and/or the more rapid restart of production is possible.

The method may be advantageously employed for a carousel-table press. The method may also be advantageously employed for a pivot-table press, in which the upper tool is braced on the pivot table.

In accordance with embodiments, a method for introducing a tool set composed of an upper tool and a lower tool, into a thermoforming machine, in which the thermoforming machine has at least one work station for a tool set which is interconnected outside of the work station, the method including at least one of the following: mounting the tool set on the at least one work station; locking a movable plate of the thermoforming machine in an operating position; displacing the lower tool and the upper tool against the movable plate; centering the upper tool on the movable plate; and securing the lower tool in a position that is predetermined by centered upper tool.

In accordance with embodiments, a method for introducing a tool set into a thermoforming machine includes at least one of the following: mounting an upper tool and a lower tool of the tool set on a work station of the thermoforming machine, the upper tool and a lower tool being interconnected outside of the work station; locking a plate of the thermoforming machine in an operating position; displacing the lower tool and the upper tool against the plate; centering and bracing the upper tool on the plate; and securing the lower tool in a position that is predetermined by the centered and braced upper tool.

### DRAWINGS

Embodiments will be illustrated by way of example in the drawings and explained in the description below.

FIG. 1 illustrates a schematic illustration of a pivot-table press, in part unequipped, in accordance with embodiments.

FIG. 2 illustrates the press equipped with a tool, in accordance with embodiments.

FIGS. 3 to 5 illustrate a method of loading a tool, in accordance with embodiments.

### DESCRIPTION

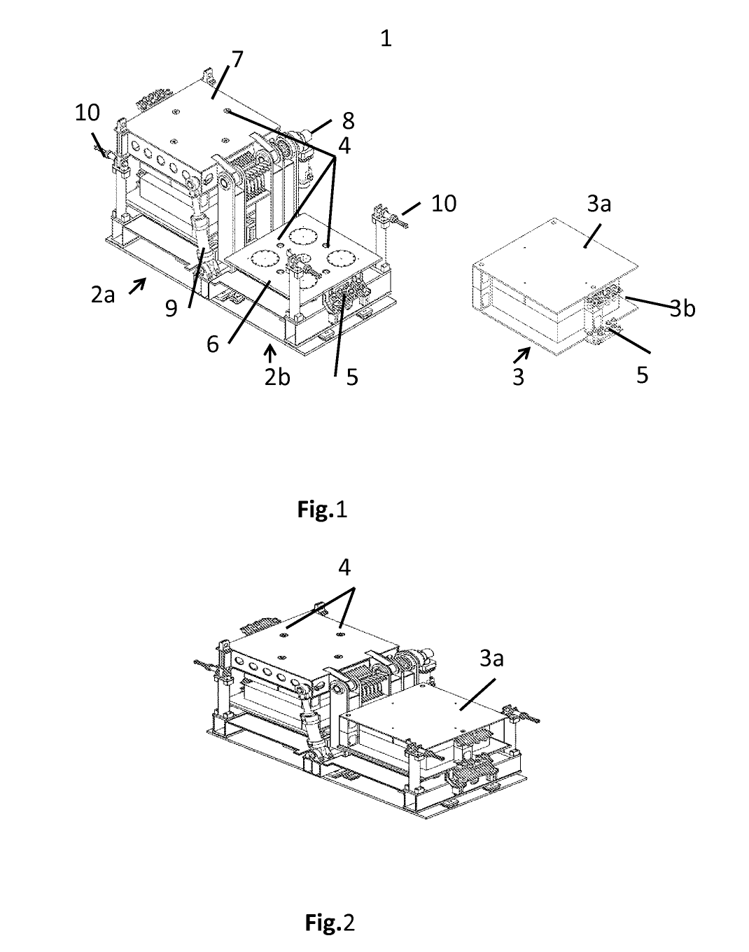

FIG. 1 illustrates a thermoform press 1, in this case, for example, a pivot-table press, having a first work station 2a and a second work station 2b. The second work station 2b is not equipped with a tool. The second tool 3 is illustrated separately in the right half of the drawing. It is composed of an upper tool 3a and a lower tool 3b, in which the two parts dispose of couplers 5. One or more centering devices and/or mechanisms 4 to center the tool 3, are attached to the table. Such a device and/or mechanism 4, in the simplest case, may be conical bores or pins, or also bracing grips or other bracing elements. If the planar table top is required for the introduction of the tool, the centering elements 4 may be executed in a retracted manner and, when the tool is placed thereon, be mechanically, electrically, pneumatically or hydraulically (or using a combination thereof) deployed and retracted again later, if and when required.

The first work station 2a has already been equipped with a first tool 3′. The pivot-table press, per se, is composed of a pair of press tables 6 and a pivot table 7 which is arranged, pivotable about an axle 8 by hydraulics 9, between the two work stations. The pivot table 7, in the illustrated situation, carries an upper tool 3a′ of the first work station 2a. The visible side of the pivot table 7 illustrates another devices and/or mechanisms 4 which serve to receive the further upper tool 3a. The pivot table 7 is locked to the work station 2a by way of the lock 10. The locks 10 of the work station 2b are open, since the counterpart in the form of the pivot table 7 is missing.

The following description illustrates the method for equipping the second work station 2b with the second tool 3. First, the tool set 3 is prepared. The tool set 3 which is composed of two tool halves, the lower tool 3b and the upper tool 3a, may even have further tool elements, such as slides, lances, etc. These additional parts may be considered component parts of the tool set.

The preheated upper tool 3a is lifted onto the likewise preheated lower tool 3b, and the two tool parts are interlocked. Centering of the two tool halves 3a, 3b takes place in this case in the tool per se, and locking may take place by way of integrated or temporarily attached, external bracing elements. No harmful warping arises on account of preheating the tool set, and the machine is operationally ready without any warming-up time.

Next, the tool set 3 then is brought above the press table 6 of the work station 2b by way of suitable lifting device or mechanism, such as a crane or a manipulator, and aligned in an approximate manner. Alignment here takes place by way of a device attached to the work station or by way of electronic and/or optical check points.

The tool set 3 is subsequently lowered onto the press table 6. Any auxiliary devices and external locks on the tool set 3 are removed; internal fastenings are loosened and/or likewise removed. Reciprocal centering of the tool halves 3a, 3b remains intact, however, since the tool halves 3a, 3b simply lie on top of one another in a planar manner. This situation, when loading the tool 3, is illustrated in FIG. 2. The pivot table 7 still lies on the first work station 2a; the tool 3, roughly pre-adjusted, has been deposited on the second work station 2b.

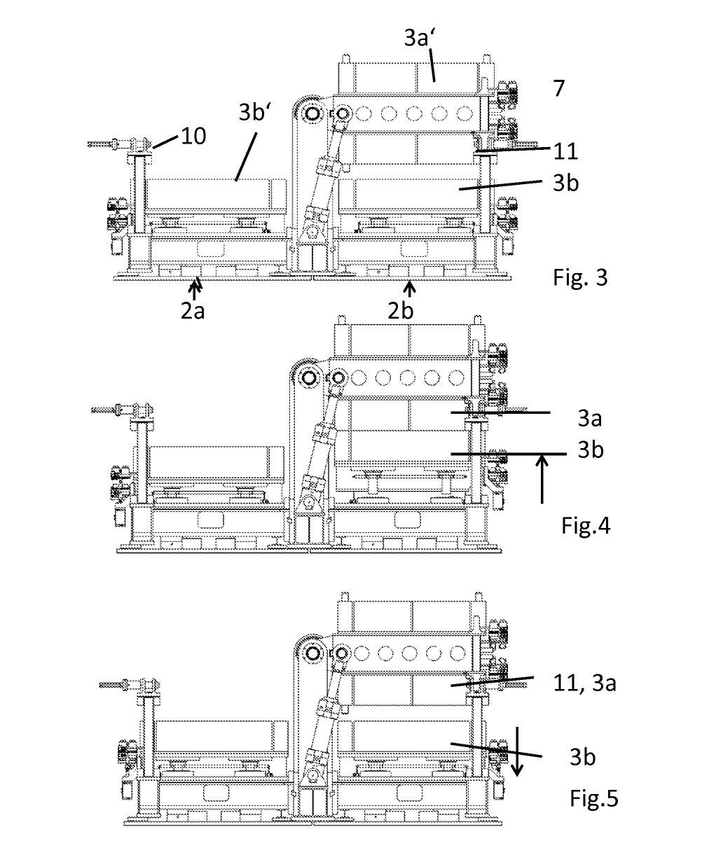

Next, the press on the work station 2b is closed and locked, using the lock 10. Here, the pivot table 7 is folded onto the tool set 3, and the lock device for the pivot table is actuated. The relative position of the components to one another can be seen in FIG. 3. The pivot table has a receptacle 11 in which the upper tool 3a is received. By way of the lock 10, the pivot table 7 is fixed in a vertical position.

As illustrated in FIG. 4, next the press table 6, by way of the press disposed spatially below the press table 6, is elevated against the locked pivot table 7. On account thereof, the tool parts, i.e., the upper tool 3a and the lower tool 3b, are also displaced vertically upwards, in which the upper tool 3a is pushed into the receptacle 11 of the pivot table.

On account of this elevation, the couplers 5 of the upper tool 3a couple to the couplers on the pivot table 7 and, on account thereof, the energy supply to the upper tool 3a is connected and the connection to air, vacuum, temperature control and electrical power is achieved.

The completely positioned tool 3 is then braced. The upper tool 3a, as the first of the two tool halves 3a, 3b, is fixed on the pivot table 7 with, for example, at least one bracing element which can transmit high forces and acts as a centering element 4. The centering elements 4 and bracing elements in the upper tool 3a define the fixed points for the entire tool 3. At this point in time, the lower tool 3b is not yet fastened on the press table 6 and, on account of the internal centering, follows the lead of the upper tool 3a. The lower tool 3b, in its final position, is subsequently secured only against displacement.

After the bracing operation, the lower tool 3b, together with the press table 6, may be lowered into the operating position; the upper tool 3a, being caught on the pivot table 7, remains above the open tool. In the case where the work station 2a were not equipped with a tool set 3, the method would proceed in an analogous manner for the other side of the pivot-table press.

The term “coupled” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SIGNS

1 Pivot-table press
2a, 2b first and second work station
3 Second tool set
3a Upper tool
3b Lower tool
4 Centering device
5 Coupler
6 Press table
7 Pivot table
8 Axle
9 Hydraulics
10 Lock
11 Receptacle
3′ first tool set

What is claimed is:

1. A method for introducing a tool set composed of an upper tool and a lower tool, into a thermoforming machine, in which the thermoforming machine has at least one work station for a tool set which is interconnected outside of the work station, the method comprising:
mounting the tool set on the at least one work station;
locking a movable plate of the thermoforming machine in an operating position;
displacing the lower tool and the upper tool against the movable plate;
centering the upper tool on the movable plate; and
securing the lower tool in a position that is predetermined by the centered upper tool.

2. The method of claim 1, wherein the upper tool is centered on the thermoforming machine via couplers.

3. The method of claim 1, further comprising, prior to mounting, preheating the tool set.

4. The method of claim 1, wherein the thermoforming machine comprises a carousel-table press.

5. The method of claim 4, wherein the lower tool bears on a press table of the carousel-table press which is vertically displaceable against the upper tool.

6. The method of claim 1, wherein the thermoforming machine comprises a pivot-table press.

7. The method of claim 6, wherein the pivot table receives the upper tool.

8. The method of claim 6, wherein the upper tool is centered on the pivot table via at least one bracing-and-centering device.

9. A method for introducing a tool set into a thermoforming machine, the method comprising:
mounting an upper tool and a lower tool of the tool set on a work station of the thermoforming machine, the upper tool and a lower tool being interconnected outside of the work station;
locking a plate of the thermoforming machine in an operating position;
displacing the lower tool and the upper tool against the plate;
centering and bracing the upper tool on the plate; and
securing the lower tool in a position that is predetermined by the centered and braced upper tool.

10. The method of claim 9, wherein the upper tool is centered on the thermoforming machine via couplers.

11. The method of claim 9, further comprising, prior to mounting, preheating the tool set.

12. The method of claim 9, wherein the thermoforming machine comprises a carousel-table press.

13. The method of claim 12, wherein the lower tool bears on a press table of the carousel-table press which is vertically displaceable against the upper tool.

14. The method of claim 9, wherein the thermoforming machine comprises a pivot-table press.

15. The method of claim 14, wherein the pivot table receives the upper tool.

16. The method of claim 14, wherein the upper tool is centered and braced on the pivot table via at least one bracing-and-centering device.
